(19) United States
(12) Patent Application Publication
(10) Pub. No.: US 2012/0105227 A1
(43) Pub. Date: May 3, 2012

(54) DISTRIBUTED SENSOR NETWORK USING EXISTING INFRASTRUCTURE

(75) Inventors: Robert C. Angell, West Greenwich, RI (US); John G. DePrimo, East Greenwich, RI (US); James T. Feeley, Saunderstown, RI (US); James H. Ferguson, East Greenwich, RI (US); James R. Lavoie, Voluntown, CT (US)

(73) Assignee: Rite-Solutions, Inc., Pawcatuck, CT (US)

(21) Appl. No.: 12/429,401

(22) Filed: Apr. 24, 2009

Related U.S. Application Data
(60) Provisional application No. 61/047,527, filed on Apr. 24, 2008.

(51) Int. Cl. G08B 21/00; G06F 15/00; G08B 25/00

(52) U.S. Cl. 340/540; 340/8.1; 702/188

(57) ABSTRACT

A distributed sensor network is provided that comprises an existing electrical system infrastructure having a plurality of nodes and providing a source of power; and a plurality of sensors. Each sensor is associated with one of the nodes in the infrastructure. In addition, each sensor obtains power from the source of power and generates sensor information regarding one or more sensed conditions that are independent of the existing electrical system infrastructure. Among other alternatives, existing electrical system infrastructure can also be used to provide a communication connection between each of the plurality of nodes and at least one central node.

### CROSS-REFERENCE TO RELATED APPLICATIONS

The present application claims the benefit of U.S. Provisional Patent Application Ser. No. 61/047,527, filed Apr. 24, 2008, incorporated by reference herein.

### FIELD OF THE INVENTION

The present invention relates to distributed sensor networks and more particularly, to techniques for distributed sensor networks based on an existing infrastructure, such as a utility grid.

### BACKGROUND OF THE INVENTION

Digital sensor networks (DSNs) are spatially dispersed fields of sensors. There is an increasing demand for DSNs for applications such as monitoring traffic flow and air quality, as well as monitoring manufacturing operations and distribution routes. Among other benefits, DSNs can optimize any proactive responses (e.g., interdiction forces) or reactive responses (e.g., emergency responders) to changes detected by the sensors.

The primary impediments to successful DSN deployments are access to sustainable power and continuous communications. In the event of a catastrophic event, for example, First Responders desire an accurate picture of what is happening. The use of biological, chemical and radiological agents to promote terrorism is a real threat. A DSN can provide a real time, broad visual footprint of the area of concern. The incoming sensor data from the DSN can be fused to a geographically referenced view that clearly illustrates sensed levels versus location and optionally an associated time stamp. An open system framework is desired for incorporation of analysis tools best suited to the classification of sensed agents.

A need exists for a DSN that provides a rapid and effective decision capability regarding the deployment of proactive or reactive responders. Yet another need exists for a DSN that provides First Responder with access to the knowledge in the data stream, thereby mitigating the cognitive stress inherent in an emergency and enabling enhanced decision making.

### SUMMARY OF THE INVENTION

Generally, a distributed sensor network is provided that comprises an existing electrical system infrastructure having a plurality of nodes and providing a source of power; and a plurality of sensors. Each sensor is associated with one of the nodes in the infrastructure. In addition, each sensor obtains power from the source of power and generates sensor information regarding one or more sensed conditions that are independent of the existing electrical system infrastructure.

According to another aspect of the invention, the existing electrical system infrastructure further comprises a communication connection between each of the plurality of nodes and at least one central node. The existing electrical system infrastructure comprises one or more of a power transmission network, a fire alarm network, a street lamp network and a cellular network. A location indication is maintained for each of the sensors, that identifies a location of the corresponding sensor.

According to another aspect of the invention, the sensor information is presented in a geographically referenced view that illustrates sensed levels as a function of location of the sensors. The geographically referenced view further comprises time-stamp information and may optionally be a three-dimensional view.

A more complete understanding of the present invention, as well as further features and advantages of the present invention, will be obtained by reference to the following detailed description and drawings.

### BRIEF DESCRIPTION OF THE DRAWINGS

FIG. 1 illustrates an existing infrastructure in which the present invention can operate;

FIG. 2 illustrates a geographically referenced view of a digital sensor network incorporating features of the present invention;

FIG. 3 is a sample table from an exemplary sensor database;

FIG. 4 is a flow chart describing an exemplary implementation of a sensor deployment process incorporating features of the present invention;

FIG. 5 is a schematic block diagram of a visualization system incorporating features of the present invention;

FIG. 6 illustrates an exemplary XML Sensor Node Message;

FIG. 7 illustrates an exemplary visualization generated by the visualization engine of FIG. 5;

FIG. 8 illustrates another exemplary visualization generated by the visualization engine of FIG. 5; and

FIG. 9 is a schematic block diagram of a digital sensor network in accordance with the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional or structural details or exemplary dimensions or angles disclosed herein are not to be interpreted as limiting, but merely as a basis for the claims and as a representative basis for teaching one skilled in the art to variously employ the present invention in virtually any appropriately detailed embodiment.

According to one aspect of the present invention, an existing power infrastructure is used to sustain the remote sensing devices and provide one of several means for communication to central or distributed Command and Control Systems. The disclosed solution thus utilizes existing infrastructure as the source for both power and communication needs. As used herein, an infrastructure comprises the basic, underlying framework or features of an electrical system, such as an electrical or telecommunications network, that provides a power source. The electrical system can include, for example, power transmission lines, fire alarm boxes, street lamps, Public Switched Telephone Networks, cellular networks and other communications networks.

According to another aspect of the invention, the sensor data is processed by a visualization engine to provide an intelligent presentation of the sensor data and thereby illuminate the knowledge contained therein.

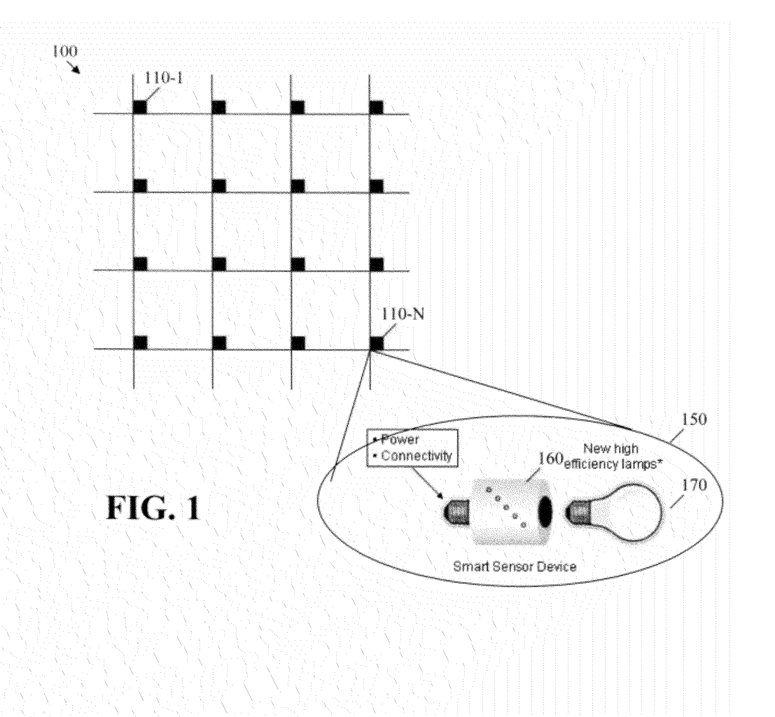

FIG. 1 illustrates an existing infrastructure 100 in which the present invention can operate. While the exemplary embodiment illustrates an exemplary infrastructure 100 having a uniform grid with a plurality of nodes 110-1 through 110-N, the present invention can also be applied in an infrastructure environment having non-uniform or randomly dispersed nodes, as would be apparent to a person of ordinary skill in the art. Each remotely deployed sensor can be installed in the existing infrastructure 100, such as street lamps, providing spatial sampling options ranging from me to course grained, as appropriate to the sensor and agents being addressed.

FIG. 1 also illustrates a sensor node 150 in further detail, corresponding to a single node 110-N in the infrastructure 100. As shown in FIG. 1, the sensor node 150 comprises a smart sensor device 160. The smart sensor device 160 comprises a sensor function, as well as power and communications connectivity, in accordance with the present invention. The exemplary smart sensor device 160 provides a receptacle for a light bulb 170. The actual sensing units are not within the scope of the present invention. The smart sensor device 160 provides power conversion and sensor interfacing, and optionally, interfaces to CPU resources and a modem for communications. The communications can be, for example, Broadband over Power Lines (BPL) technology, Wireless Fidelity (WiFi), radio, deployed fiber or any combination thereof. With IPV-6 (Internet Protocol version 6), for example, each sensor will have its own IP address.

Digital Sensor Network

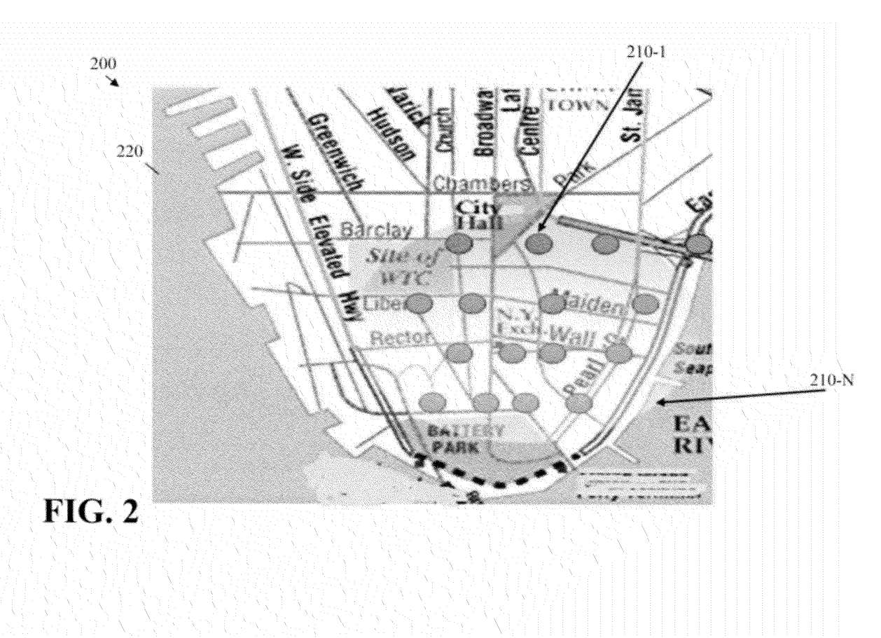

FIG. 2 illustrates a geographically referenced view of a digital sensor network 200 incorporating features of the present invention. As shown in FIG. 2, the digital sensor network 200 comprises a number of geographically dispersed sensors 210-1 through 210-N, optionally overlayed on a map 220. The circles represent the locations of the sensors 210-1 through 210-N and the sensor information between them can be interpolated or extrapolated to produce an effects map illustrated by the shading applied over the sensors locations. The map 220 optionally provides geographically referenced coordinates with accurate overlays of the area being sensed: roads, buildings, and other features important to optimizing response time to an effected area.

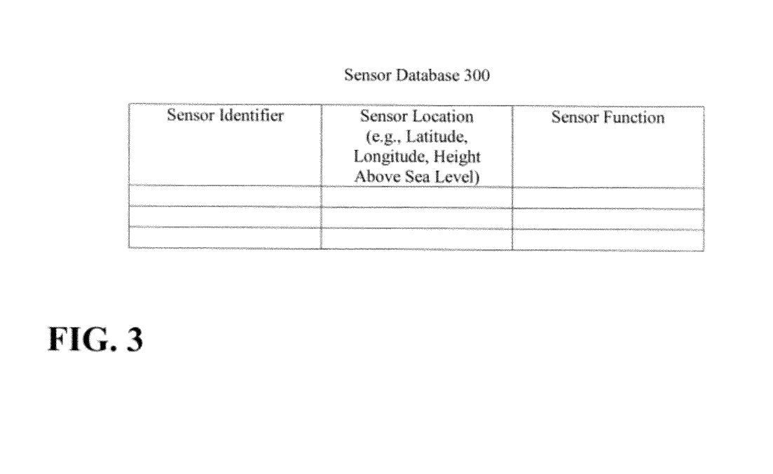

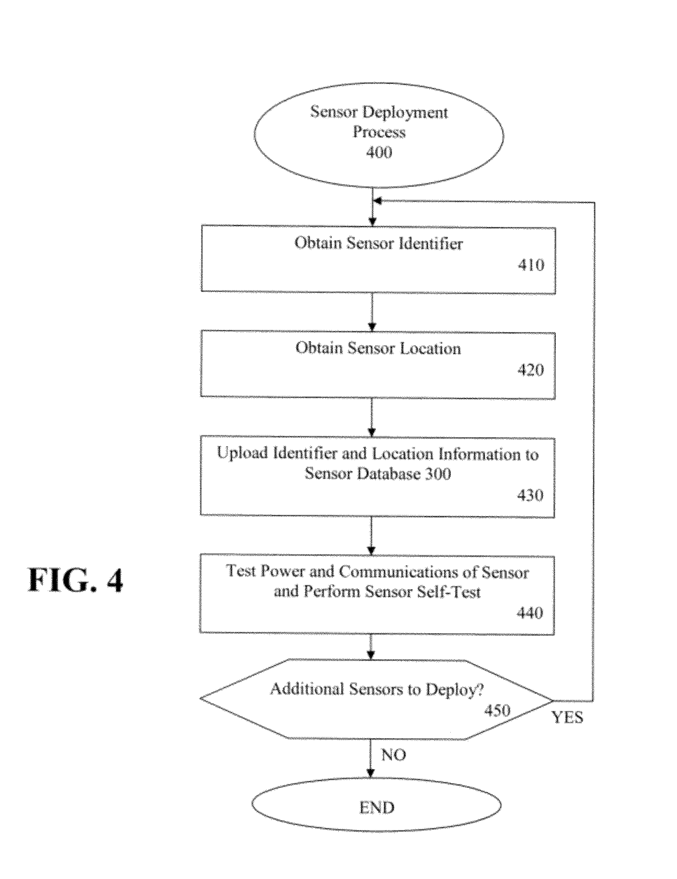

FIG. 3 is a sample table from an exemplary sensor database 300. As shown in FIG. 3, the sensor database 300 comprises a plurality of records, each associated with a different sensor in the digital sensor network 200. For, each sensor, the exemplary sensor database 300 indicates a sensor identifier, sensor location and sensor function (such as biological, chemical or radiological sensor). The information recorded in the exemplary sensor database 300 may be populated, for example, by the sensor deployment process 400, discussed hereinafter in conjunction with FIG. 4.

FIG. 4 is a flow chart describing an exemplary implementation of a sensor deployment process 400 incorporating features of the present invention. As shown in FIG. 4, the sensor deployment process 400 initially obtains a sensor identifier during step 410, for example, during the installation of the sensor. In one implementation, during manufacture of the sensing devices, a unique bar code is attached to each sensor. Alternatively, a RFID device could be used. The bar code can indicate, for example, the physical address (MAC), the sensor type and calibration coefficients, as required.

Thereafter, the exemplary sensor deployment process 400 obtains the location of the sensor 210 being deployed during step 420. For example, when installing the sensor device 210, a GPS reading of the location can be obtained (e.g., integral to the scanning tool) and scanning the bar code to simultaneously obtain the sensor identifier and location. In a further variation, the installer can provide a record of the physical location (for example, utility company pole number or GPS) with the sensor ID such that the sensor web may be rendered. In yet another variation, each sensor can self detect its location (for example, using a GPS device, or reading location information from a connector associated with the sensor. The correlation of the location with each sensor identifier in the database 300 allows a visualization to be obtained in a geographically referenced domain. In yet another variation, the latitude, longitude and height information can be recorded for each sensor. A sensor self-test function would assure the installer that the sensing component is functioning properly.

The obtained sensor identifier and location information is optionally uploaded to the sensor database 300 during step 430. In one exemplary implementation, an IP address will be dynamically assigned but the MAC address is fixed in the modem firmware. The power and communications capabilities of the deployed sensor 210 are optionally tested and a self-test can optionally be performed during step 440.

A test is performed during step 450 to determine if there are additional sensors to deploy. If it is determined during step 450 that there are additional sensors to deploy, then program control returns to step 410. If, however, it is determined during step 450 that there are no additional sensors to deploy, then program control terminates.

Visualization Engine

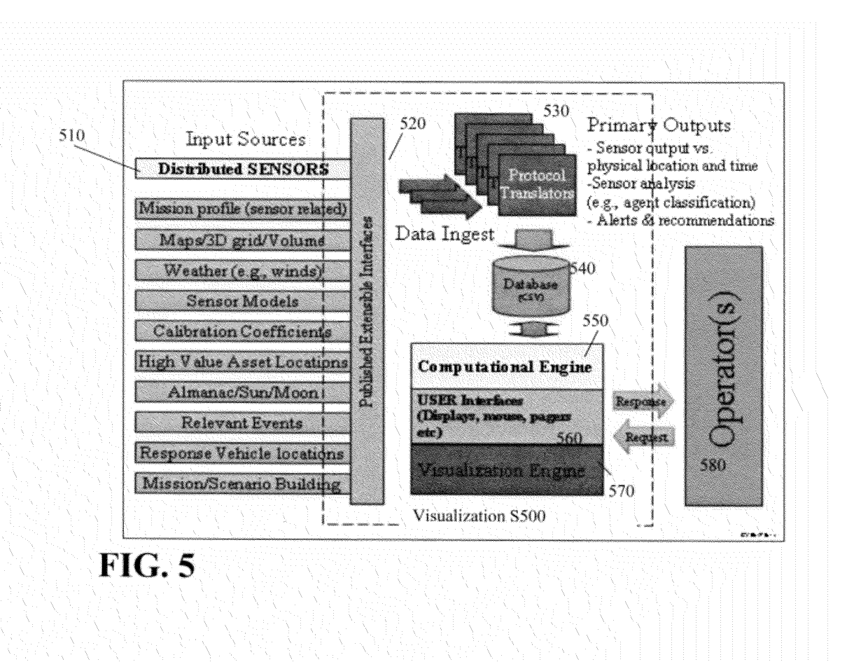

As previously indicated, the sensor data is processed by a visualization engine that achieves information fusion, discussed below in conjunction with FIG. 5, to provide an intelligent presentation of the sensor data and thereby illuminate the knowledge contained therein. An important aspect of the disclosed digital sensor network 100 is the ability to ingest large quantities of data and render aspects of that data in an appropriate visualization environment. In one exemplary implementation, a three-dimensional plus time visualization environment is provided that is synchronized to the geographical features of the area being monitored. In addition, the visualization environment changes with time and can be correlated with other relevant information, such as schools, traffic flow, weather, and wind speed. The system nodes in the digital sensor network can be distributed over any area and with full redundancy through oversampling. The elimination of one node does not eliminate the ability to access the system information. System drill down, zoom in/zoom out at any point is optionally provided as a means to more accurately quantify the effects area. Census data bases optionally provide insight into the residential and/or business human density that can be correlated with the affected area.

As discussed hereinafter, the visualization component of the digital sensor network provides an end-to-end solution, which includes the required hardware and software necessary to power, decode, process and communicate the sensor data while also providing a distributed capability to render and analyze the agent with respect to the sensed area.

FIG. 5 is a schematic block diagram of a visualization system 500 incorporating features of the present invention. As shown in FIG. 5, the exemplary visualization system 500 processes data from distributed sensors 510, and one or more of mission profile, digital nautical charts, satellite imagery, maps, weather, sensor models, calibration coefficients, high value asset locations, sun and moon almanac, relevant events, response vehicle locations, and mission/scenarios. The data from the input sources conform to a published extensible interface 520. The data is ingested and translated, if necessary, by one or more protocol translators 530, before being stored in a database 540.

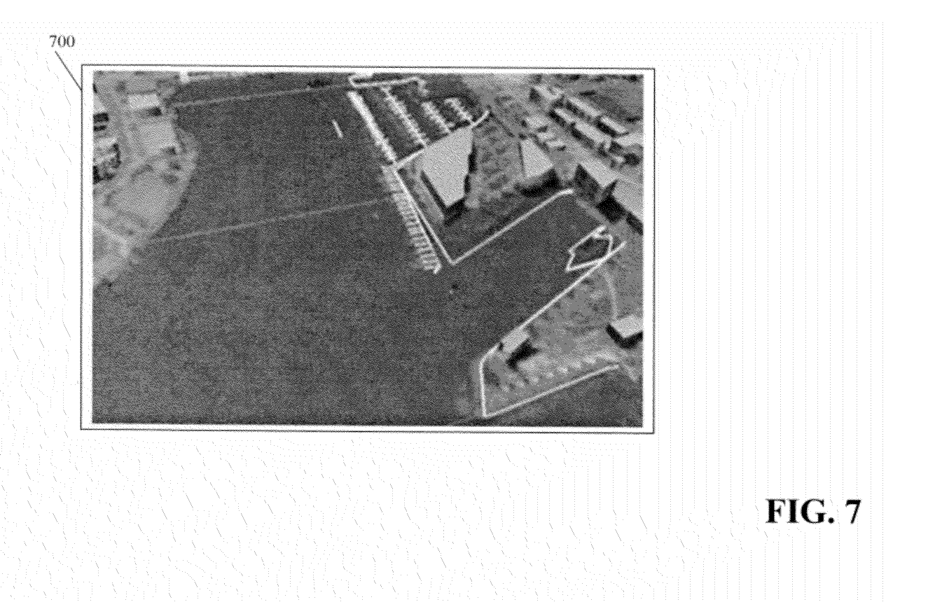

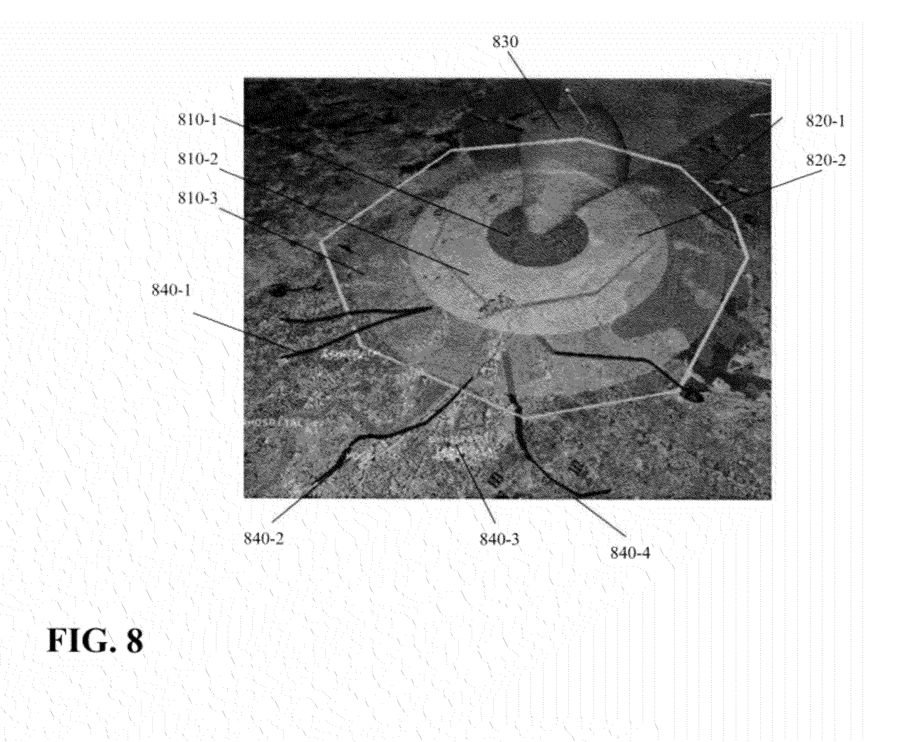

The visualization system 500 comprises a computational engine 550, one or more user interfaces 560 and a visualization engine 570. As shown in FIG. 5, requests from operators 580 are processed by the visualization system 500 and responses are returned to the operators 580. As previously indicated, the visualization system 500 provides the sensor outputs as a function of geographic sensor location, as well as a sensor analysis. Exemplary visualizations are discussed below in conjunction with FIGS. 7 and 8.

In one exemplary embodiment, the visualization engine is embodied as the “RiteView™” product, commercially available from Rite-Solutions, Incorporated of Middletown, R.I. See, for example, http://www.ritesolutions.com/home.html, incorporated by reference herein. RiteView™ can display data from seabed to space, and is an interactive product designed to spatially fuse disparate data types into a cohesive three-dimensional picture. The generated visualizations facilitate analysis and depth of understanding leading to the best decisions possible. RiteView™ can create a high fidelity synthetic view of any area by ingesting maps, elevation data and other Geographic Information System (GIS) referenced data bases. Allowing users to pause, go back look closer and then catch up to real time without losing any data is an important feature to end users concerned with the reconstruction and analyses of an event. RiteView™ is open and scalable. As shown in FIG. 5, inputs to the application can be handled using protocol translators/data streams.

The RiteView™ macro capability provides the ability for sensors with different types of data to be added to the digital sensor network 100 without having to make software code changes within the network or in the Rite-View™ Visualization engine 500. This will be accomplished by using the Extensible Markup Language (XML) and creating a unique sensor type for the specific sensor including the ability to have more than one sensor connected to a CPU sensor node. In the following example, a chemical sensor capable of detecting lethal gases has been added as a sensor node on the DSN. As previously indicated, during the configuration of the sensor node, the unique sensor type ID is entered into the memory on the CPU board along with other information, such as latitude, longitude, height, date/time installed and sample rate. The CPU then takes sensor readings through the sensor interface and creates an XML message that includes all the necessary information and then forwards that data through the communications channel.

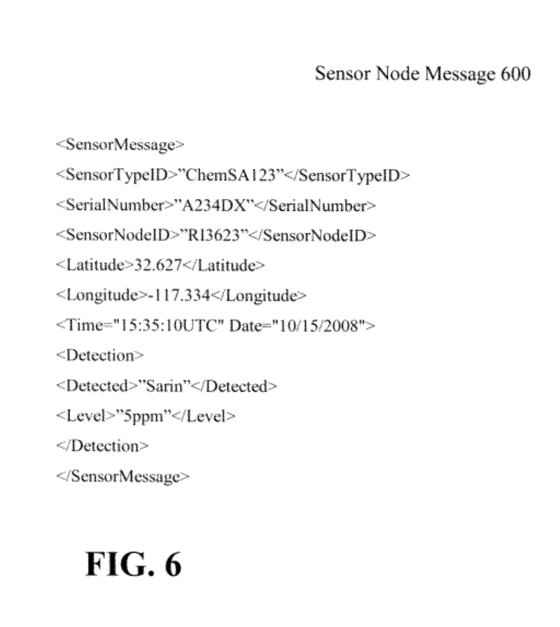

FIG. 6 illustrates an exemplary XML Sensor Node Message 600. The XML messages, such as message 600, are collected and passed through communications channels and make their way to a Rite-View™ configured visualization engine 500 that can display all the sensor locations and data. When a new sensor type ID is received that has not been seen before, a user interface is popped up with the data that is parsed using the XML format. The operator 580 highlights the fields that are to be displayed in RiteView™ and selects alert levels. For this particular sensor, any detection is considered dangerous and will cause an alert that includes both a indication in the GIS, a text display in the alert window, and a audible alarm. The display would also include indications of sensors that are no longer working and need to be replaced. Once the system is configured for a particular sensor type id, the system will automatically process the XML message allowing the system to be easily extended as new sensors are added to the DSN.

The user interface (UI) allows the operator using the XML message to be processed by selecting XML fields and choosing actions to be assigned to the message fields. Actions could include displaying the information in a text instrument or 2D graph, assign to an alert, and display in a GIS using a 2D symbol to represent the data and location. These DSN message settings will be saved and can be changed if needed.

As the messages, such as message 600, go through the DSN, additional XML tags are added to identify the channels that the message traveled to get to the System that include nodes and times than can be used to evaluate the health of the DSN and be used to identified bottle necks and places where redundant channels are needed to ensure all sensed messages get through. Using a descriptive massage format, such as XML, allows the ability to add multiple new sensors on the DSN allowing the operators to automatically process them, removing the need for software code changes to support new sensor technologies.

Among other capabilities, the visualization engine 500 can convert the sensor information to toxicity levels, estimate the population in affected regions from census information, indicate the direction of the plume versus time as a function of prevailing winds, and map the best routes to hospitals or for evacuation, all on the same display. The distributed sensors are but one source of information. The exemplary visualization engine 500 can ingest disparate data sources (real time, data bases, etc.) and render them visually for use by the operator 580. The computational engine 550 can also process the data for classification clues, and through the use of smart agents, send alerts and recommendations to key response personnel to provide mitigation as soon as possible.

FIG. 7 illustrates an exemplary visualization 700 generated by the visualization engine 500 of FIG. 5. The exemplary visualization 700 illustrates a synthetic view of a portion of the Charles River area in Boston, Mass. The exemplary information fusion display 700 was created by fusing data from many sources and formats including: Digital Terrain Data from LIDAR (laser ranging), Bathymetry, Digital Nautical Chart, satellite imagery, Census TIGER roads data, shape files, 3D city model, various 2D textures, and environmental data like wind direction and speed. All data is ingested and displayed using their geospatial data (latitude, longitude, altitude) and fused into a synthetic display that is cognitive intuitive to understand. Included in the information display of the exemplary embodiment would be sensor locations, sensed data values, alerts, and sensor status (example time since last sensor data value received).

FIG. 8 illustrates another exemplary visualization 800 generated by the visualization engine 500 of FIG. 5. The exemplary information fusion display 800 illustrates that sensed information, when combined with historical geospatial data, provides the ability to gain situational awareness and to make effective decisions. In the example of FIG. 8, a dirty bomb was exploded at Logan Airport in Boston, Mass. and the concentric circles 810-1 through 810-3 show anticipated levels of radiation based on the size of the bomb. The closed polygons 820-1 and 820-2 show the anticipated expected power and communications outages. The location of the plume 830 is displayed using sensed information from the DSN sensors indicating which way the radiation plume is actually moving over time. The linear lines, such as lines 840-1 through 840-4, show best routes to evacuate injured persons to trauma designated hospitals. When the DSN sensed data is combined with the other GIS data (for example, population density from census), it provides the dynamic situational awareness view necessary to respond to a man made or natural event.

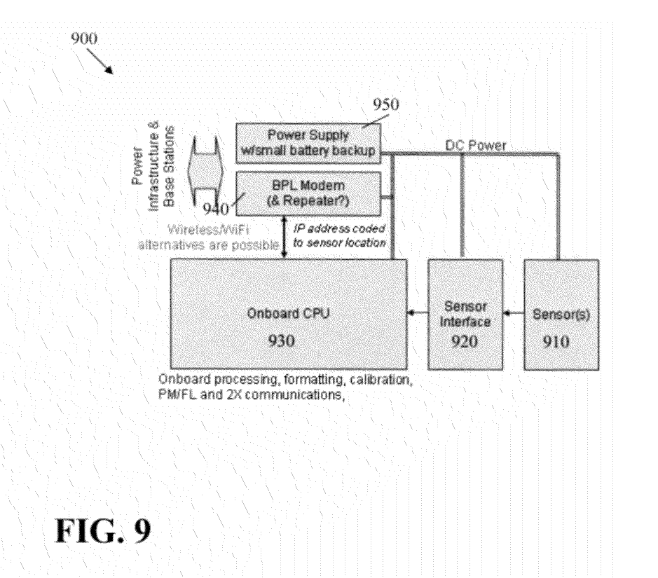

FIG. 9 is a schematic block diagram of a digital sensor network 900 in accordance with the present invention. As shown in FIG. 9, the digital sensor network 900 comprises a plurality of sensors 910 that are connected through sensor interfaces 920. The sensors 910 and sensor interfaces 920 obtain any necessary power from a power supply 950 that optionally also includes a battery backup. The sensor interfaces 920 connect the sensors 910 to a central processing unit (CPU) 930. The CPU 930 provides access to a communication channel, for example, through a modem 940.

### CONCLUSION

Various aspects of the present invention provide for (1) the use of existing infrastructure as a means to solve sensor endurance, communications and covert deployment issues; (2) the use of advanced visualization and data rendering technology to exploit an effective Digital Sensor Network with end-to-end system capability; and (3) the ability to utilize a reliable and identifiable communications channel without requiring an on board power source. In this manner, the existing infrastructure is extended to provide a sensor grid. In addition, the existing infrastructure is leveraged to provide a power source for the sensors, which may optionally also include a battery backup. This access to power and communications also creates the ability to perform on-the-fly sensor reconfiguration, calibration, performance monitoring/fault localization for each sensor. These elements give the First Responder the tools to act
proactively: sensing trace agents and directing interdiction forces before the terrorist act is committed, and
reactively: sensing the magnitude and extent as a direct function if geographical location, and, with overlay of suitable data bases, sensing and predicting the direction and rate of movement of the agent.

While the invention has been described with reference to illustrative embodiments, dimensions and angles, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

While a number of the figures herein show an exemplary sequence of steps, it is also an embodiment of the present invention that the sequence may be varied. Various permutations of the algorithm are contemplated as alternate embodiments of the invention. While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments with the processor to provide a device that operates analogously to specific logic circuits. The invention can also be implemented in one or more of an integrated circuit, a digital signal processor, a microprocessor, and a micro-controller.

### System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A distributed sensor network, comprising:
an existing electrical system infrastructure having a plurality of nodes and providing a source of power; and
a plurality of sensors, wherein each of said sensors are associated with one of said nodes, wherein each of said plurality of sensors obtains power from said source of power and wherein each of said plurality of sensors generates sensor information regarding one or more sensed conditions that are independent of said existing electrical system infrastructure.

2. The distributed sensor network of claim 1, wherein said existing electrical system infrastructure further comprises a communication connection between each of said plurality of nodes and at least one central node.

3. The distributed sensor network of claim 1, wherein said existing electrical system infrastructure comprises one or more of a power transmission network, a fire alarm network, a street lamp network and a cellular network.

4. The distributed sensor network of claim 1, wherein a location indication is maintained for each of said sensors.

5. The distributed sensor network of claim 4, wherein said location indication identifies a location of said corresponding sensor.

6. The distributed sensor network of claim 1, wherein said sensor information is presented in a geographically referenced view that illustrates sensed levels as a function of location of said sensors.

7. The distributed sensor network of claim 6, wherein said geographically referenced view further comprises time-stamp information.

8. The distributed sensor network of claim 6, wherein said geographically referenced view is a three-dimensional view.

9. The distributed sensor network of claim 1, wherein said sensor information indicates a level of one or more biological, chemical or radiological agents.

10. A method for establishing a distributed sensor network, comprising:
adding a plurality of sensors to an existing electrical system infrastructure having a plurality of nodes and providing a source of power, wherein each of said sensors are associated with one of said nodes, wherein each of said plurality of sensors obtains power from said source of power and wherein each of said plurality of sensors generates sensor information regarding one or more sensed conditions that are independent of said existing electrical system infrastructure.

11. The method of claim 10, further comprising the step of employing said existing electrical system infrastructure to provide a communication connection between each of said plurality of nodes and at least one central node.

12. The method of claim 10, wherein said existing electrical system infrastructure comprises one or more of a power transmission network, a tire alarm network, a street lamp network and a cellular network.

13. The method of claim 10, further comprising the step of maintaining a location indication for each of said sensors.

14. The method of claim 13, wherein said location indication identifies a location of said corresponding sensor.

15. The method of claim 10, further comprising the step of presenting said sensor information in a geographically referenced view that illustrates sensed levels as a function of location of said sensors.

16. The method of claim 15, wherein said geographically referenced view further comprises time-stamp information.

17. The method of claim 15, wherein said geographically referenced view is a three-dimensional view.

18. The method of claim 10, wherein said sensor information indicates a level of one or more biological, chemical or radiological agents.
